(19) United States
(12) Patent Application Publication
(10) Pub. No.: US 2025/0385994 A1
(43) Pub. Date: Dec. 18, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Tomokazu SATO, Tokyo (JP)

(21) Appl. No.: 19/230,179

(22) Filed: Jun. 6, 2025

(30) Foreign Application Priority Data
Jun. 18, 2024 (JP) 2024-097987

(51) Int. Cl. H04N 13/111; G06T 3/40; G06T 7/529; G06T 7/55; G06T 7/80; G06T 7/90

(52) U.S. Cl. CPC H04N 13/111; G06T 3/40; G06T 7/529; G06T 7/55; G06T 7/80; G06T 7/90; G06T 2207/10024; G06T 2207/20081

(57) ABSTRACT

An image processing apparatus: obtains a plurality of captured images obtained by image capturing from a plurality of positions, and a plurality of camera parameters on a plurality of viewpoints corresponding to the plurality of positions; generates a camera parameter on a complement viewpoint that is different from the plurality of viewpoints; obtains shape data of an object estimated based on the obtained plurality of camera parameters and the obtained plurality of captured images; generates a complement viewpoint image based on the shape data and the generated camera parameter; and generates information on a three-dimensional field corresponding to a space that is at least part of an image capturing space subjected to image capturing from the plurality of positions, the information being generated based on the obtained plurality of camera parameters, the obtained plurality of captured images, the generated camera parameter, and the generated complement viewpoint image.

### BACKGROUND

### Field

The present disclosure relates to an image processing technology for generating a virtual viewpoint image.

### Description of the Related Art

There is a technology that generates an image corresponding to a view from any viewpoint (hereinafter referred to as “virtual viewpoint”) (hereinafter such an image will be referred to as “virtual viewpoint image”) by using a plurality of captured images obtained by image capturing from a plurality of different viewpoints (hereinafter referred to as “multi-viewpoint images”). Japanese Patent Laid-Open No. 2023-066705 discloses a technology called Neural Radiance Fields (NeRF) as a method of generating a virtual viewpoint image. NeRF includes a neural network that returns a density and a color in response to any position and direction, and volume rendering that calculates the pixel value of each pixel by accumulating colors obtained at a plurality of sampling points on a ray corresponding to the pixel according to the respective densities. The neural network in NeRF is trained using the pixel values of captured images that form multi-viewpoint images as training data such that the squared errors between these pixel values and pixel values calculated by the volume rendering are obtained as losses.

### SUMMARY

Here, some image capturing conditions may require positions or directions from which it is difficult for an image capturing apparatus to capture images, such as an angle of view that looks up an object to be imaged (hereinafter referred to simply as “object”) from below. In such a case, it is impossible to obtain captured images corresponding to such positions or directions. This may lead to a situation where the position of a virtual viewpoint or the viewing direction from the virtual viewpoint significantly differs from any of the positions or directions of the viewpoints used in the training of the neural network in NeRF. In such a case, the reproduction fidelity of the representation of the object included in the virtual viewpoint image is greatly impaired, which has been a problem with the conventional NeRF.

An image processing apparatus according to the present disclosure includes: one or more hardware processors; and one or more memories storing one or more programs configured to be executed by the one or more hardware processors, the one or more programs including instructions for: obtaining data of a plurality of captured images obtained by image capturing from a plurality of positions; obtaining a plurality of camera parameters on a plurality of viewpoints corresponding to the plurality of positions; generating a camera parameter on a complement viewpoint that is different from the plurality of viewpoints; obtaining shape data indicating a three-dimensional shape of an object estimated based on the obtained plurality of camera parameters and the obtained data of the plurality of captured images; generating a complement viewpoint image corresponding to a view from the complement viewpoint based on the shape data and the generated camera parameter; and generating three-dimensional field information on a three-dimensional field corresponding to a space that is at least part of an image capturing space subjected to image capturing from the plurality of positions, the three-dimensional field information being generated based on the obtained plurality of camera parameters, the obtained data of the plurality of captured images, the generated camera parameter, and data of the generated complement viewpoint image.

Further features of the present disclosure will become apparent from the following description of exemplary embodiments with reference to the attached drawings.

### BRIEF DESCRIPTION OF THE DRAWINGS

FIG. 1 is a diagram illustrating an example of an image processing system according to a first embodiment;

FIG. 2A is a block diagram illustrating an example of a hardware configuration of an image processing apparatus according to the first embodiment, and FIG. 2B is a block diagram illustrating an example of a hardware configuration of an information processing apparatus according to the first embodiment;

FIGS. 3A and 3B are diagrams for describing a problem with the conventional NeRF;

FIGS. 4A and 4B are diagrams for describing an example of a virtual viewpoint image generated by the conventional NeRF;

FIG. 5 is a diagram illustrating an example of a radiance field obtained as a result of training of the conventional NeRF;

FIGS. 6A and 6B are diagrams for describing an example of a virtual viewpoint image obtained by the conventional NeRF;

FIG. 7 is a diagram illustrating an example of the position and direction of a virtual viewpoint that may decrease the reproduction fidelity of a virtual viewpoint image obtained by the conventional NeRF;

FIG. 8 is a diagram illustrating an example of complement viewpoints according to the present disclosure;

FIGS. 9A and 9B are diagrams illustrating an example of a virtual viewpoint image and a complement viewpoint image according to the present disclosure;

FIG. 10A is a block diagram illustrating an example of a functional configuration of the image processing apparatus according to the first embodiment;

FIG. 10B is a block diagram illustrating an example of a functional configuration of the information processing apparatus according to the first embodiment;

FIG. 11A is a flowchart illustrating an example of a flow of processing by the image processing apparatus according to the first embodiment;

FIG. 11B is a flowchart illustrating an example of a flow of processing by the information processing apparatus according to the first embodiment;

FIG. 12 is a diagram for describing an example of a method of generating complement camera parameters according to the first embodiment;

FIG. 13 is a diagram illustrating an example of a graphical user interface (GUI) according to the first embodiment;

FIG. 14 is a block diagram illustrating an example of a functional configuration of an image processing apparatus according to a second embodiment;

FIG. 15 is a flowchart illustrating an example of a flow of processing by the image processing apparatus according to the second embodiment; and

FIG. 16 is a flowchart illustrating an example of a flow of processing for generating complement camera parameters according to the second embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Note that identical components will be described with the same reference sign given thereto. Also, each of the steps in the flowcharts to be described later will be represented using a reference sign starting with “S.”

In the following description, a two-dimensional region in an image will be referred to simply as “region,” and a three-dimensional region in an image capturing space or a virtual space will be referred to as “space.” Also, the following embodiments will each describe a method of generating a learned model on the assumption that the learned model is generated by training a learning model obtained by modeling a field that exists in a three-dimensional manner (hereinafter referred to as “three-dimensional field”) in an image capturing space to be subjected to image capturing. Also, the following embodiments will be described on the assumption that the learning model obtained by modeling a three-dimensional field (hereinafter referred to as “three-dimensional field model”) is a radiance field by a NeRF including a multilayer perceptron, but the three-dimensional field model is not limited to this.

The method of representing the three-dimensional field varies depending on the contents of the training. Specifically, for example, the three-dimensional field model may be constructed by Instant Neural Graphics Primitives (NGP), which is a high-speed technique similar to NeRF. Also, the three-dimensional field model is not limited to one constructed by a multilayer perceptron, and may be constructed by Plenoxels or Tensorial Radiance Fields (TensoRF), which explicitly represent three-dimensional fields, or the like. Also, the three-dimensional field model may be constructed by Neural Surface Reconstruction (NeuS), which provides improved accuracy in shape estimation with a representation of a three-dimensional field by the signed distance field (SDF), or the like. Also, the three-dimensional field model may be constructed by various techniques, such as 3D Gaussian Splatting, such that the three-dimensional field is represented by a set of points with spatial extent.

### First Embodiment

### <Configuration of Image Processing System>

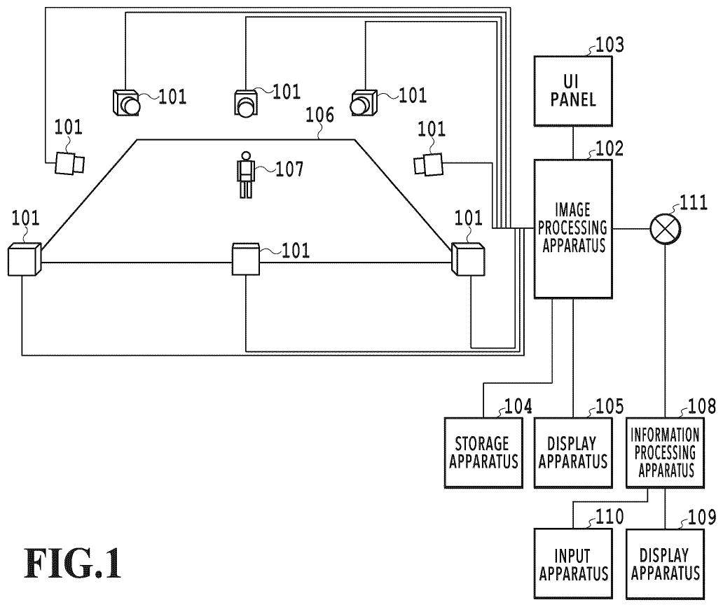

FIG. 1 is a diagram illustrating an example of an image processing system according to a first embodiment. The image processing system has a plurality of image capturing apparatuses 101, an image processing apparatus 102, a user interface (hereinafter referred to as “UI”) panel 103, a storage apparatus 104, a display apparatus 105, an information processing apparatus 108, a display apparatus 109, and an input apparatus 110.

The plurality of image capturing apparatuses 101 include digital still cameras, digital video cameras, or the like, and the image capturing apparatuses 101 are placed at different positions each other. The image capturing apparatuses 101 capture images of an object 107 present in an image capturing space 106 from different viewpoints under preset image capturing conditions in synchronization with each other to obtain data of a plurality of captured images corresponding to the viewpoints (multi-viewpoint images). Note that the synchronized image capturing does not mean capturing images simultaneously but means capturing images with synchronization processing. That is, the synchronized image capturing does not need to be image capturing operations performed at exactly the same time, and includes image capturing operations performed at substantially the same time. The data of the captured images obtained by the image capturing by the image capturing apparatuses 101 (hereinafter referred to as “captured image data”) may be data of still images or data of moving images or data of both still images and moving images. The following description will be given on the assumption that the term “image” has meanings of both “still image” and “moving image,” unless otherwise noted. The captured image data obtained by each image capturing apparatus 101 is transmitted to the image processing apparatus 102.

The image processing apparatus 102 obtains the data of the plurality of captured images (multi-viewpoint images) transmitted from the plurality of image capturing apparatuses 101, and performs trains a three-dimensional field being a space including the object 107 that is present in the image capturing space 106 by using the obtained multi-viewpoint images. Information representing a learned three-dimensional field obtained as a result of the training by the image processing apparatus 102 is output to the information processing apparatus 108 through a network 111, such as the Internet. The information, or a signal, representing the learned three-dimensional field may be output to the storage apparatus 104, the display apparatus 105, and the like. Also, the image processing apparatus 102 may generate a virtual viewpoint image based on the three-dimensional field in training or the learned three-dimensional field obtained as a result of the training. In this case, data or signal of the virtual viewpoint image generated by the image processing apparatus 102 is output to, for example, the storage apparatus 104, the display apparatus 105, and the like.

Note that the present embodiment will be described on the assumption that each of the plurality of image capturing apparatuses 101 and the image processing apparatus 102 are connected to each other as illustrated in FIG. 1, but how the image capturing apparatuses 101 and the image processing apparatus 102 are connected to each other is not limited to this. Specifically, for example, the image capturing apparatuses 101 located adjacent to each other may be connected to thereby cascade the plurality of image capturing apparatuses 101, and at least one of the plurality of image capturing apparatuses 101 may be connected to the image processing apparatus 102.

Also, the present embodiment will be described on the assumption that the plurality of image capturing apparatuses 101 are placed at different positions as illustrated in FIG. 1 as an example, the number and layout of the image capturing apparatuses 101 are not limited to this example. For example, in a case where the position, shape, and color of the object 107 present in the image capturing space 106, the intensity or color of the ambient light, and so on do not change over time, at least one image capturing apparatus 101 whose position and orientation are changeable may be placed. In this case, this image capturing apparatus 101 may be caused to capture an image at each of a plurality of different positions while the position and orientation of the image capturing apparatus 101 are changed, and the image processing apparatus 102 may obtain the plurality of pieces of captured image data obtained by this image capturing as data of multi-viewpoint images.

A UI panel 103 includes a display device, such as a liquid crystal panel, and displays on this display device a GUI for presenting information to the user, such as image capturing conditions for the image capturing apparatuses 101 and processing settings of the image processing apparatus 102. Also, the UI panel 103 may include an input device, such as a touch panel or buttons, in which case the UI panel 103 receives instructions from the user for changing the image capturing conditions or processing settings mentioned above and for performing other operations. In this case, information representing the instructions from the user received by the UI panel 103 is transmitted to the image processing apparatus 102. The input device may be provided as a separate body from the UI panel 103, such as a mouse or a keyboard.

The storage apparatus 104 includes a hard disk drive or the like, and obtains data of virtual viewpoint images output from the image processing apparatus 102 and stores the obtained data. Also, the storage apparatus 104 obtains information representing three-dimensional fields output from the image processing apparatus 102 and stores the obtained information.

The display apparatus 105 includes a liquid crystal display or the like, and obtains signals of images to be displayed that include virtual viewpoint images output from the image processing apparatus 102 and displays the virtual viewpoint images corresponding to the signals. Also, the display apparatus 105 obtains signals of images to be displayed that include images of three-dimensional fields output from the image processing apparatus 102 and displays the images of the three-dimensional fields corresponding to the signals.

The image capturing space 106 is a three-dimensional space surrounded by the plurality of image capturing apparatuses 101 installed in a studio or the like. In FIG. 1, the frame depicted with a solid line represents the outline of the image capturing space 106 on the floor surface. The following will exemplarily describe an aspect for capturing images of one or more objects from around the object or objects with eight image capturing apparatuses 101 installed in a studio. Also, while the description will be given on the assumption that camera parameters of each image capturing apparatus 101 are stored in a storage device 204 in advance, the image processing apparatus 102 may estimate the camera parameters by using captured image data. In this case, the image processing apparatus 102 estimates the camera parameters of each image capturing apparatus 101 by using, for example, an algorithm COLMAP, which is well known in the field of technologies such as NeRF and which estimates image capturing positions and at the same time estimates the shapes of objects based on captured images.

The camera parameters include intrinsic parameters, extrinsic parameters, a distortion parameter, and so on. Here, the intrinsic parameters are parameters indicating the coordinates of the centers of captured images obtained by image capturing by the image capturing apparatus and the focal length of its lens. Also, the extrinsic parameters are parameters indicating the position and orientation of the image capturing apparatus, and the distortion parameter is a parameter indicating the distortion of its lens. Note that the plurality of image capturing apparatuses 101 may share common camera parameters, in particular, common intrinsic parameters and distortion parameter. Note that the distortion parameter and so on other than the intrinsic parameters and the extrinsic parameters are data optionally included as camera parameters, and does not necessarily need to be included as camera parameters.

The information processing apparatus 108 generates virtual viewpoint images based on information representing a learned three-dimensional field output from the image processing apparatus 102. Data or signals of the virtual viewpoint images generated by the information processing apparatus 108 are output to the display apparatus 109 or the like, for example. The display apparatus 109 has a similar configuration to that of the display apparatus 105, and description thereof is therefore omitted. The input apparatus 110 includes a mouse, a keyboard, or the like, and receives input operations from the user of the information processing apparatus 108 and transmits input signals corresponding to the input operations to the information processing apparatus 108.

### <Hardware Configurations of Image Processing Apparatus and Information Processing Apparatus>

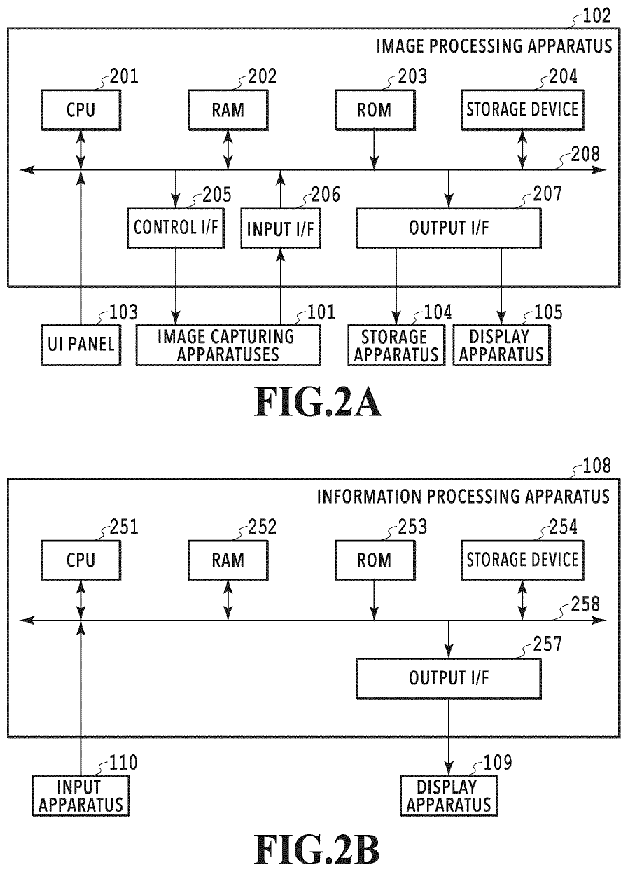

FIG. 2A is a block diagram illustrating an example of a hardware configuration of the image processing apparatus 102 according to the first embodiment. FIG. 2B is a block diagram illustrating an example of a hardware configuration of the information processing apparatus 108 according to the first embodiment. The image processing apparatus 102 has a central processing unit (CPU) 201, a random-access memory (RAM) 202, a read-only memory (ROM) 203, the storage device 204, a control interface (hereinafter referred to as “I/F”) 205, an input I/F 206, an output I/F 207, and a main bus 208 as its hardware components.

The CPU 201 is a processor that comprehensively controls components of the image processing apparatus 102. The CPU 201 executes an operating system (OS) and various programs stored in the ROM 203, the storage device 204, or the like with the RAM 202 as a work memory. The CPU 201 comprehensively controls the image processing apparatus 102 through the main bus 208 by executing the various programs. Note that the process in each of the steps illustrated in the later-described flowchart that involves the image processing apparatus 102 is implemented by loading program code stored in the ROM 203, the storage device 204, or the like to the RAM 202 and causing the CPU 201 to execute this. The RAM 202 functions as a main memory, a work area, and the like for the CPU 201. The ROM 203 stores a set of programs to be executed by the CPU 201. The storage device 204 includes a hard disk drive or the like, and stores application programs to be executed by the CPU 201, various data to be used in processes by the CPU 201, and so on.

The control I/F 205 is connected to each of the plurality of image capturing apparatuses 101, and is a communication interface for controlling the setting of the image capturing conditions for each image capturing apparatus 101, starting of image capturing, stopping of image capturing, so on. The input I/F 206 is a communication interface employing a serial bus complying with Serial Digital Interface (SDI), High-Definition Multimedia Interface (registered trademark) (HDMI (registered trademark)), or the like. Captured image data output from each image capturing apparatus 101 is obtained via the input I/F 206. The output I/F 207 is a communication interface employing a serial bus complying Universal Serial Bus (USB), IEEE 1394, or the like. Data or signals of virtual viewpoint images, three-dimensional fields, and the like are output to the storage apparatus 104 or the display apparatus 105 via the output I/F 207. The main bus 208 is a transfer channel by which the above-described hardware components of the image processing apparatus 102 are communicatively connected to one another.

The information processing apparatus 108 has a CPU 251, a RAM 252, a ROM 253, a storage device 254, an output I/F 257, and a main bus 258 as its hardware components. The CPU 251 is a processor that comprehensively controls components of the information processing apparatus 108. The CPU 251 executes an OS and various programs stored in the ROM 253, the storage device 254, or the like with the RAM 252 as a work memory. The CPU 251 comprehensively controls the information processing apparatus 108 through the main bus 258 by executing the various programs. Note that the process in each of the steps illustrated in the later-described flowchart that involves the information processing apparatus 108 is implemented by loading program code stored in the ROM 253, the storage device 254, or the like to the RAM 252 and causing the CPU 251 to execute this. The RAM 252 functions as a main memory, a work area, and the like for the CPU 251.

The ROM 253 stores a set of programs to be executed by the CPU 251. The storage device 254 includes a hard disk drive or the like, and stores application programs to be executed by the CPU 251, various data to be used in processes by the CPU 251, and so on. The output I/F 257 is a communication interface employing a serial bus complying USB, IEEE 1394, or the like. Signals representing virtual viewpoint images are output to the display apparatus 109 via the output I/F 257. The main bus 258 is a transfer channel by which the above-described hardware components of the information processing apparatus 108 are communicatively connected to one another.

### <Training of NeRF>

Since the present embodiment will be exemplarily described on the assumption that a three-dimensional field is expressed by a radiance field by NeRF, training of NeRF will be generally described first. NeRF includes a neural network that outputs a volume density σ and a color (r, g, b) in response to a five-dimensional input variable including three-dimensional coordinates (x, y, z) indicating any spatial position and a direction (θ, φ). Here, the elements of the color (r, g, b) are values corresponding to colors of red (R), green (G), and blue (B), respectively. To obtain a pixel value (r, g, b), a plurality (N (N is a positive integer of 2 or more) of sampling points Pᵢ (i is a positive integer of N or more) on a ray corresponding to the pixel are prepared first. Subsequently, the positions (x, y, z) of the sampling points Pᵢ and the direction (θ, φ) of the ray are input into the neural network, and the neural network in turn outputs a volume density σᵢ and a color cᵢ at each sampling point Pᵢ. Further, using a rendering technique called volume rendering, which is capable of expressing translucent objects, a color weight sum cᵢ based on the volume densities σᵢ is calculated, thereby determining a pixel value Cᵥ.

In the volume rendering, a cumulative transmittance Tᵢ at each sampling point Pᵢ is firstly obtained based on the volume density and the distance between sampling points. The cumulative transmittance Tᵢ represents the ratio at which the color cᵢ at the sampling point Pᵢ reaches the image capturing position. Specifically, the cumulative transmittance Tᵢ is calculated using Equation (1), for example.

$${T}_{i} = exp ( - {\sum }_{j = 1}^{i - 1} {σ}_{j} {δ}_{j} ) \qquad Equation ( l )$$

Here, δⱼ denotes the distance from a current sampling point Pⱼ to the next sampling point Pⱼ₊₁. As described in Equation (1), the cumulative transmittance Tᵢ is a value that becomes smaller as the value of a volume density σⱼ becomes larger in the calculation process. In the volume rendering, a weight wᵢ for the color cᵢ at each sampling point Pᵢ is subsequently obtained based on the cumulative transmittance Tᵢ, the volume density σᵢ, and the distance δⱼ. Further, the pixel value Cᵥ is obtained based on the color cᵢ and the weight wᵢ. Specifically, the weight wᵢ is calculated using Equation (2), for example, and the pixel value Cᵥ is calculated through a weighted addition of the color cᵢ using Equation (3), for example.

$${w}_{i} = {T}_{i} ( 1 - exp ( - {σ}_{i} {δ}_{i} ) ) \qquad Equation ( 2 )$$

$$Cv ( r ) = {\sum }_{i = 1}^{{N}_{c}} {w}_{i} {c}_{i} \qquad Equation ( 3 )$$

In the training of the neural network in NeRF, the squared error between the pixel value Cᵥ obtained by the volume rendering and the value of the corresponding pixel in the captured image data serving as training data (pixel value C) is firstly obtained as a loss L. Subsequently, weight parameters of the neural network are changed by any method using the obtained loss L, such as backpropagation. The loss L is calculated using Equation (4), for example.

$$L = {\sum }_{r ∈ R} {‖ Cv ( r ) - C ( r ) ‖}_{2}^{2} \qquad Equation ( 4 )$$

Note that generating a virtual viewpoint image from a desired virtual viewpoint by using the learned neural network will involve executing processing similar to the volume rendering executed in the training.

<Problem with Conventional NeRF>

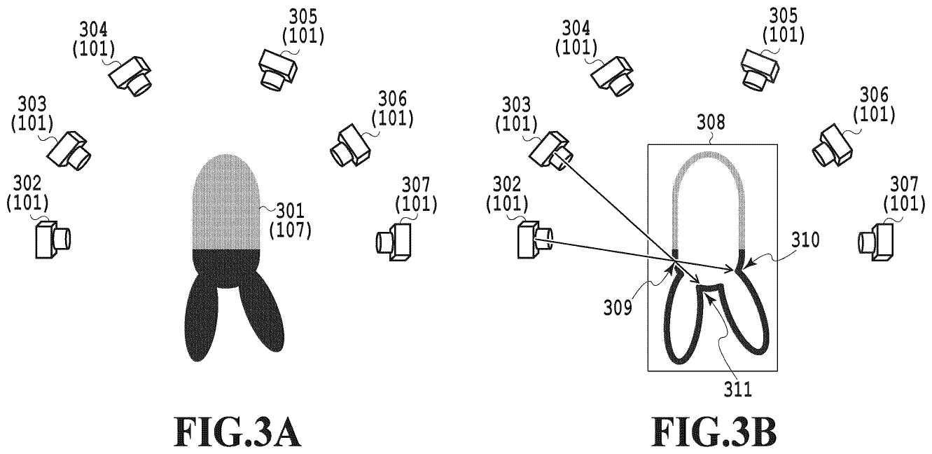

Before specifically describing the embodiment according to the present disclosure, a problem with the conventional NeRF will be described. FIGS. 3A and 3B are diagrams for describing a problem with the conventional NeRF. FIG. 3A illustrates an example of a state where images of an object 301 are being captured by image capturing apparatuses 101 installed on walls, a ceiling, pillars, or the like (image capturing apparatuses 302 to 307 in FIGS. 3A and 3B). Specifically, FIG. 3A illustrates a state where the image capturing space 106 is viewed from a horizontal direction. In a case of capturing images of a moving object, such as a natural person, the image capturing apparatuses cannot be installed in a space within which the object is allowed to move. For this reason, as exemplarily illustrated in FIG. 3A, it may be difficult to install image capturing apparatuses at such positions as to look up at and capture images of an object.

FIG. 3B illustrates an example of a radiance field (three-dimensional field) 308 for the object 301 obtained by training of NeRF. Specifically, FIG. 3B illustrates a cross section of the radiance field for the object 301 parallel to the vertical direction as viewed from the above-mentioned horizontal direction. Note that the image capturing apparatuses 302 to 307 illustrated in FIGS. 3A and 3B indicate the positions and orientations of the image capturing apparatuses estimated by calibration. In FIG. 3B, the colors at positions where the density is more than or equal to a predetermined level are illustrated in the original colors of the object 301. By training a radiance field by NeRF, the density will be high at positions corresponding to the surface of the object 301 in the density field represented by the radiance field.

However, under image capturing conditions where it is difficult to install image capturing apparatuses in certain directions as described above, the density may become low at a certain position 309 corresponding to the surface of the object 301. Such a phenomenon occurs in a case where the color at the position 309 and positions 310 and 311 at which rays corresponding to pixels in captured images corresponding to the low-density position intersect corresponding curved surfaces in the surface of the object 301 in the radiance field are similar to one another. In this case, even if the density at the position 309 near positions corresponding to the positions of the image capturing apparatuses 302 and 303 is small, the pixel value obtained by the volume rendering will be close to the pixel value in the captured image serving as training data. As a result, the loss L calculated based on the pixel value obtained by the volume rendering and the pixel value in the captured image serving as training data will be small. Due to this small loss L, the training of the three-dimensional field model will converge without increasing the density at the position 309.

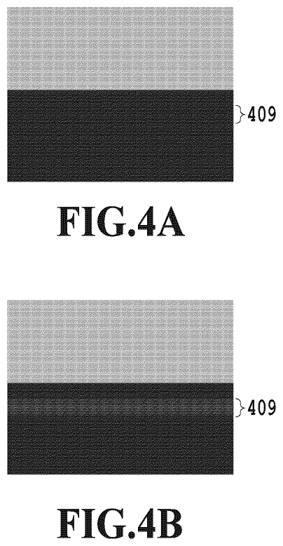

FIGS. 4A and 4B are diagrams for describing an example of a virtual viewpoint image generated by the conventional NeRF. FIG. 4A illustrates an example of the position 309 and an image region around it in a captured image obtained by image capturing by the image capturing apparatus 303. Also, FIG. 4B illustrates an example of this image region in a virtual viewpoint image generated based on the position and viewing direction of a virtual viewpoint corresponding to the position and orientation of the image capturing apparatus 303 and on the radiance field 308. In FIGS. 4A and 4B, a region 409 is a pixel region corresponding to the position 309. The color of the region 409 in the captured image illustrated in FIG. 4A, which is a pixel region corresponding to the position 309, is the same as the color of the surface of the object 301 (107) at a position corresponding to the position 309 illustrated in FIG. 3B. The color of the region 409 in the virtual viewpoint image illustrated in FIG. 4B, which is a pixel region corresponding to the position 309, is the same as the color at the position 311 illustrated in FIG. 3B. The color at the position 311 illustrated in FIG. 3B is close to the color of the surface of the object 301 (107) at the position corresponding to the position 309 illustrated in FIG. 3B. For this reason, the training of the three-dimensional field model converges while the density of the position 309 is still low.

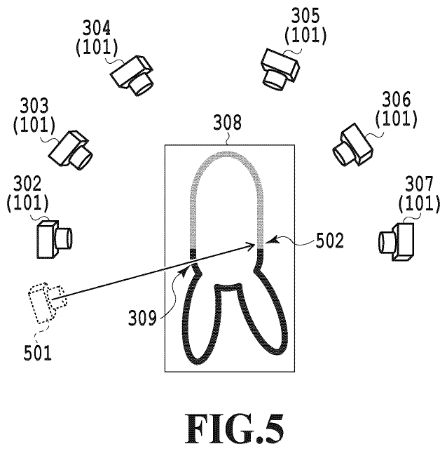

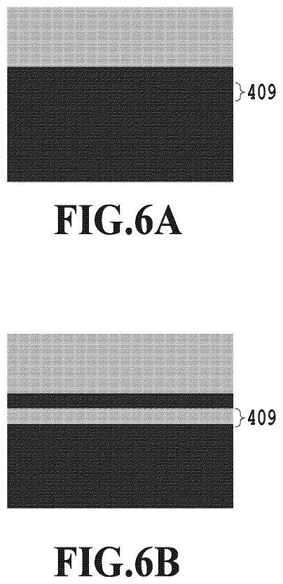

A decrease in the reproduction fidelity of a virtual viewpoint image will now be described with reference to FIG. 5 and FIGS. 6A and 6B. FIG. 5 is a diagram illustrating an example of the radiance field 308 obtained as a result of training of the conventional NeRF. Consider a ray which, as illustrated in FIG. 5, penetrates the radiance field 308 and passes the position 309 corresponding to a surface of the object in the radiance field 308, at which the density is low, and a position 502 corresponding to a surface of the object. Note that the color of the surface of the object at the position 309 in the radiance field 308 and the color of the surface of the object at the position 502 are different colors, as illustrated in FIG. 5.

FIGS. 6A and 6B are diagrams for describing an example of a virtual viewpoint image obtained by the conventional NeRF. Specifically, FIG. 6A illustrates an example of an image accurately reproducing the view from the virtual viewpoint, and FIG. 6B illustrates an example of a virtual viewpoint image obtained by using the radiance field 308 obtained as a result of the training of the conventional NeRF. The color of the region 409 in the virtual viewpoint image illustrated in FIG. 6B is desirably and supposed to be the same color as the region 409 illustrated in FIG. 6A, which is the color of the surface of the object at the position 309. However, with the radiance field 308 illustrated in FIG. 5, the color of the region 409 in the virtual viewpoint image illustrated in FIG. 6B is the color of the surface of the object at the position 402. An actually generated virtual viewpoint image differing from an expected virtual viewpoint image as described above represents an example of the decrease in the reproduction fidelity of a virtual viewpoint image.

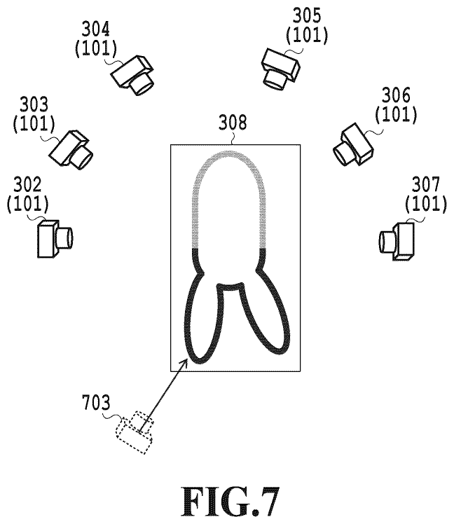

The reproduction fidelity of a virtual viewpoint image also decreases in cases other than ones as described using FIG. 5. FIG. 7 is a diagram illustrating an example of the position and direction of a virtual viewpoint that may decrease the reproduction fidelity of a virtual viewpoint image obtained by the conventional NeRF. Even in a case where the density is high at all positions corresponding to the surface of the object in the density field represented by the radiance field 308, a virtual viewpoint image may be generated such that a representation of the object is expressed in a different color than the actual appearance. Examples include a case where, as exemplarily illustrated in FIG. 7, the position and direction of a virtual viewpoint 703 are significantly far and different from the positions or image capturing directions (orientations) of the image capturing apparatuses 101 (302 to 307 in FIG. 7). In FIG. 7, there is no image capturing apparatus 101 that captures images of the object at such an angle as to look up the object from below like the virtual viewpoint 703. Thus, it is impossible to train the radiance field 308 by using data of captured images obtained by image capturing at such angles as training data. Also, NeRF models are designed to accommodate direction-dependent color changes. Thus, without captured image data as mentioned above as training data, no loss will be generated during the training, which may result in unstable solutions.

### <Basic Concept of Present Disclosure>

To solve the problem with the conventional NeRF described above, the present disclosure generates complementary images corresponding to views from complementary viewpoints by a method different from a three-dimensional field model by NeRF or the like, and utilizes data of these images as training data in the training of the three-dimensional field model. This is intended to improve the reproduction fidelity of a virtual viewpoint image corresponding to a view from a virtual viewpoint in a direction in which none of the image capturing apparatuses 101 captures images. In the following, the complementary viewpoints will be referred to as “complement viewpoints” and the complementary images will be referred to as “complement viewpoint images.”

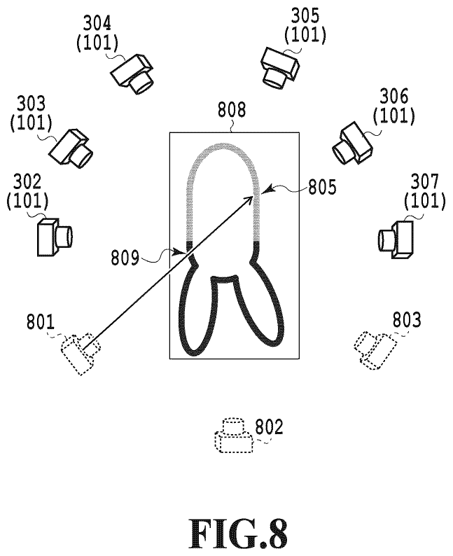

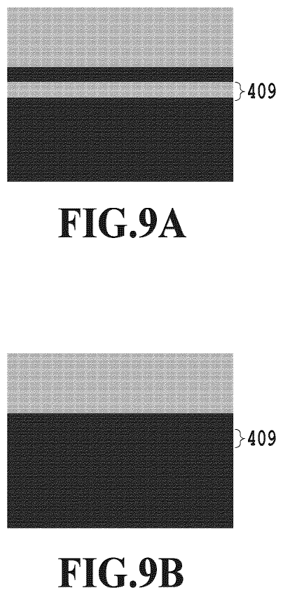

FIG. 8 is a diagram illustrating an example of complement viewpoints 801 to 803 according to the present disclosure. Also, FIG. 8 illustrates a radiance field 808 obtained as a result of additionally performing training using data of the above-mentioned complement viewpoint images as training data. FIGS. 9A and 9B are diagrams illustrating an example of a virtual viewpoint image and a complement viewpoint image corresponding to a view from the complement viewpoint 801 according to the present disclosure. Specifically, FIG. 9A is an example of a virtual viewpoint image corresponding to a view from the complement viewpoint 801, and FIG. 9B is an example of a complement viewpoint image corresponding to the view from the complement viewpoint 801. Adding training that uses data of complement viewpoint images corresponding to views from the complement viewpoints 801 to 803 as training data reduces the occurrence of a phenomenon as illustrated in FIG. 3B, in which the training of the three-dimensional field model converges while the density at the position 309 is still low. Specifically, adding training that uses data of the complement viewpoint image exemplarily illustrated in FIG. 9B increases the density at the position 309 in the density field represented by the radiance field 808. In a case where the density at the position 309 in the radiance field 808 in training is low, a ray that passes the position of the complement viewpoint 801 and a position 809 reaches a position 805. That is, the color of the region 409 corresponding to the position 809 in the virtual viewpoint image exemplarily illustrated in FIG. 9A, which is generated using the radiance field 808 in training, is the color of the surface of the object at a position corresponding to the position 805, as illustrated in FIG. 6B. Thus, there is a difference, i.e., a loss, between the pixel value at the region 409 corresponding to the position 809 in the virtual viewpoint image and the pixel value at the region 409 corresponding to the position 809 in the complement viewpoint image exemplarily illustrated in FIG. 9B. The training of the radiance field 808 is performed so as to reduce this loss. Such training increases the density at the position 809 in the density field represented by the radiance field 808.

With the learned radiance field 808 obtained as a result of such training, the color of the pixels corresponding to the position 809 in a virtual viewpoint image will be the same as or similar to the color of the surface of the object at a position corresponding to the position 809 regardless of the direction in which the virtual viewpoint is set. Also, using data of images corresponding to views from directions in which none of the image capturing apparatuses 101 is placed relative to the image capturing space (complement viewpoint images) as training data prevents the training of the radiance field 808 from converging with colors that are far different from the actual ones as solutions.

### <Functional Configurations of Image Processing Apparatus and Information Processing Apparatus>

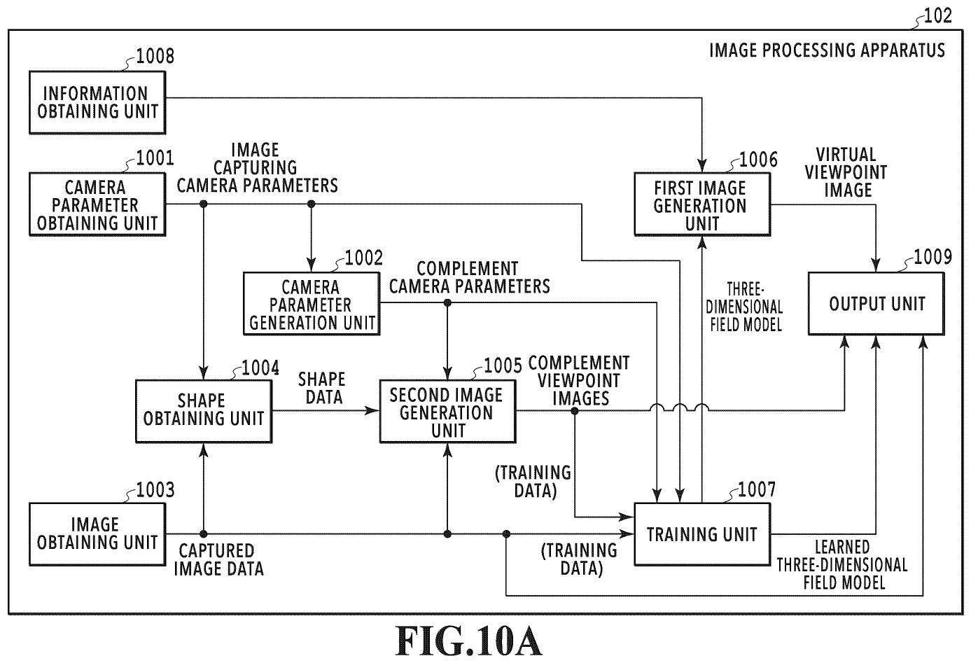

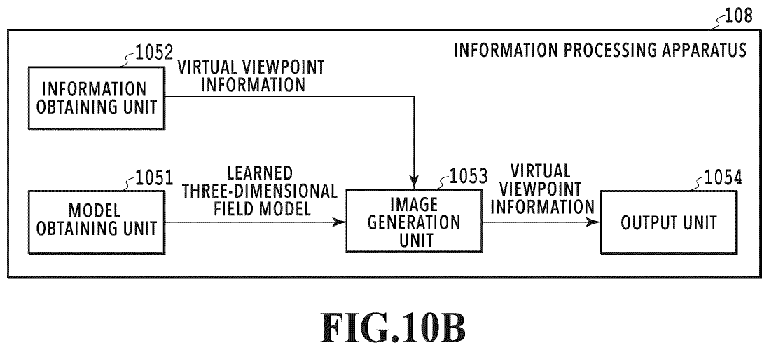

Functional configurations of the image processing apparatus 102 and the information processing apparatus 108 will now be described with reference to FIGS. 10A and 10B. FIG. 10A is a block diagram illustrating an example of the functional configuration of the image processing apparatus 102 according to the first embodiment. The image processing apparatus 102 has a camera parameter obtaining unit 1001, a camera parameter generation unit 1002, an image obtaining unit 1003, a shape obtaining unit 1004, a second image generation unit 1005, a first image generation unit 1006, a training unit 1007, an information obtaining unit 1008, and an output unit 1009 as its functional components. The units included in the image processing apparatus 102 as its functional components are each implemented by causing the CPU 201 to execute a program stored in the ROM 203 or the like with the RAM 202 as a work memory. Note that not all of the processes to be described below necessarily need to be implemented by causing the CPU 201 to execute a program, and the image processing apparatus 102 may be configured to execute some or all of the processes with one or more processing circuits other than the CPU 201.

The camera parameter obtaining unit 1001 obtains the camera parameters of each image capturing apparatus 101 (hereinafter referred to as “image capturing camera parameters”). The image capturing camera parameters obtained by the camera parameter obtaining unit 1001 are transmitted to the camera parameter generation unit 1002, the shape obtaining unit 1004, the first image generation unit 1006, and the training unit 1007.

The camera parameter generation unit 1002 generates camera parameters that are different from the image capturing camera parameters transmitted from the camera parameter obtaining unit 1001 (hereinafter referred to as “complement camera parameters”) based on information on a training space and the image capturing camera parameters. In the following description, the information on the training space will be referred to as “training space information.” While the present embodiment will be described on the assumption that the training space information is held in advance in the camera parameter generation unit 1002, the camera parameter generation unit 1002 may obtain the training space information by reading it out of the storage device 204. The complement camera parameters are camera parameters of an image capturing apparatus that performs virtual image capturing from complementary viewpoints different from the viewpoints of the image capturing apparatuses 101 (complement viewpoints) (this image capturing apparatus will also be referred to as “virtual camera”). Here, the image capturing camera parameters and the complement camera parameters share the same data structure (data format). That is, like the image capturing camera parameters, the complement camera parameters include extrinsic parameters, intrinsic parameters, a distortion parameter, and so on. Details of processing for generating the complement camera parameters by the camera parameter generation unit 1002 will be described later. The complement camera parameters generated by the camera parameter generation unit 1002 are transmitted to the first image generation unit 1006, the second image generation unit 1005, and the training unit 1007.

The image obtaining unit 1003 obtains captured image data obtained by image capturing by each of the plurality of image capturing apparatuses 101. The sources from which to obtain captured image data are not limited to the image capturing apparatuses 101. The image obtaining unit 1003 may obtain captured image data by reading them out of the storage apparatus 104 or the like. The captured image data obtained by the image obtaining unit 1003 is transmitted to the shape obtaining unit 1004 and the second image generation unit 1005. Also, the captured image data obtained by the image obtaining unit 1003 is transmitted to the training unit 1007 as training data for the training of a three-dimensional field model in training.

The shape obtaining unit 1004 obtains shape data indicating the three-dimensional shape of the object present in the training space. For example, using the image capturing camera parameters and the captured image data, the shape obtaining unit 1004 estimates the three-dimensional shape of the object present in the training space to thereby obtain shape data representing the three-dimensional shape of the object. Details of processing for estimating the three-dimensional shape by the shape obtaining unit 1004 will be described later. The shape data obtained by the shape obtaining unit 1004 is transmitted to the second image generation unit 1005.

The second image generation unit 1005 generates images corresponding to views from the complement viewpoints (complement viewpoint images) by using the shape data, the captured image data, and the complement camera parameters. Details of processing for generating the complement viewpoint images by the second image generation unit 1005 will be described later. Data of the complement viewpoint images generated by the second image generation unit 1005 (hereinafter referred to as “complement viewpoint image data”) is transmitted to the training unit 1007 as training data for the training of the three-dimensional field model in training.

The first image generation unit 1006 generates a virtual viewpoint image by using the three-dimensional field model in training and virtual viewpoint information obtained from the information obtaining unit 1008 to be described later. This virtual viewpoint image is a virtual viewpoint image generated by the three-dimensional field model in training to be checked by the user. The virtual viewpoint image generated during the training by the first image generation unit 1006 is transmitted to the output unit 1009. Also, using a learned three-dimensional field model and the virtual viewpoint information, the first image generation unit 1006 generates a virtual viewpoint image corresponding to a view from the position of a virtual viewpoint indicated by virtual viewpoint information as well. The virtual viewpoint image generated by the first image generation unit 1006 by using the learned three-dimensional field model is transmitted to the output unit 1009.

The training unit 1007 trains the three-dimensional field model. Specifically, the training unit 1007 trains the three-dimensional field model by using the captured image data and the complement viewpoint image data as training data. After finishing the whole training, the training unit 1007 transmits data of the learned three-dimensional field model to the output unit 1009.

The information obtaining unit 1008 obtains virtual viewpoint information including at least information on the position of a virtual viewpoint and information on the viewing direction from the virtual viewpoint. The virtual viewpoint information obtained by the information obtaining unit 1008 is transmitted to the first image generation unit 1006.

Note that the image processing apparatus 102 may be configured such that the user may check the complement viewpoint images generated by the second image generation unit 1005. In this case, the complement viewpoint images are transmitted to the output unit 1009 from the second image generation unit 1005. The complement viewpoint images are then output to, for example, the UI panel 103, the display apparatus 105, or the like by the output unit 1009.

The output unit 1009 outputs the learned three-dimensional field model. For example, the output unit 1009 outputs data of the learned three-dimensional field model to the storage apparatus 104 to store the data in the storage apparatus 104. The output destination for the output unit 1009 is not limited to the storage apparatus 104. For example, the output unit 1009 may output signals of an image to be displayed that includes an image representing the learned three-dimensional field model to the display device of the UI panel 103, the display apparatus 105, or the like, to display the image on the display device. Also, the output unit 1009 may output the virtual viewpoint image generated using the three-dimensional field model in training or the learned three-dimensional field model in addition to the learned three-dimensional field model. In this case, the output unit 1009, for example, outputs data of the virtual viewpoint image to the storage apparatus 104 to store the data in the storage apparatus 104. Also, the output unit 1009 may, for example, output the virtual viewpoint image to the display device of the UI panel 103, the display apparatus 105, or the like to display the virtual viewpoint image on the display device.

FIG. 10B is a block diagram illustrating an example of a functional configuration of the information processing apparatus 108 according to the first embodiment. The information processing apparatus 108 has a model obtaining unit 1051, an information obtaining unit 1052, an image generation unit 1053, and an output unit 1054 as its functional components. The units included in the information processing apparatus 108 as its functional components are each implemented by causing the CPU 251 to execute a program stored in the ROM 253 or the like with the RAM 252 as a work memory. Note that not all of the processes to be described below necessarily need to be implemented by causing the CPU 251 to execute a program, and the information processing apparatus 108 may be configured to execute some or all of the processes with one or more processing circuits other than the CPU 251. The model obtaining unit 1051 obtains a learned three-dimensional field model output from the image processing apparatus 102. The learned three-dimensional field model obtained by the model obtaining unit 1051 is transmitted to the image generation unit 1053.

The information obtaining unit 1052 obtains virtual viewpoint information including at least information on the position of a virtual viewpoint and information on the viewing direction from the virtual viewpoint. For example, the virtual viewpoint information is input based on an input operation on the input apparatus 110 from the user of the information processing apparatus 108. The virtual viewpoint information obtained by the information obtaining unit 1052 is transmitted to the image generation unit 1053. Note that the virtual viewpoint information obtained by the information obtaining unit 1052 may be output to the image processing apparatus 102 through the network 111. In this case, the information obtaining unit 1008 obtains the virtual viewpoint information output to the image processing apparatus 102. Using the learned three-dimensional field model transmitted from the model obtaining unit 1051 and the virtual viewpoint information transmitted from the information obtaining unit 1052, the image generation unit 1053 generates a virtual viewpoint image corresponding to a view from the position of the virtual viewpoint indicated by the virtual viewpoint information. Data of the virtual viewpoint image generated by the image generation unit 1053 is transmitted to the output unit 1054. The output unit 1054 outputs the virtual viewpoint image transmitted from the image generation unit 1053 to the display apparatus 109. The display apparatus 109 displays the virtual viewpoint image output from the output unit 1054.

### <Operations of Image Processing Apparatus and Information Processing Apparatus>

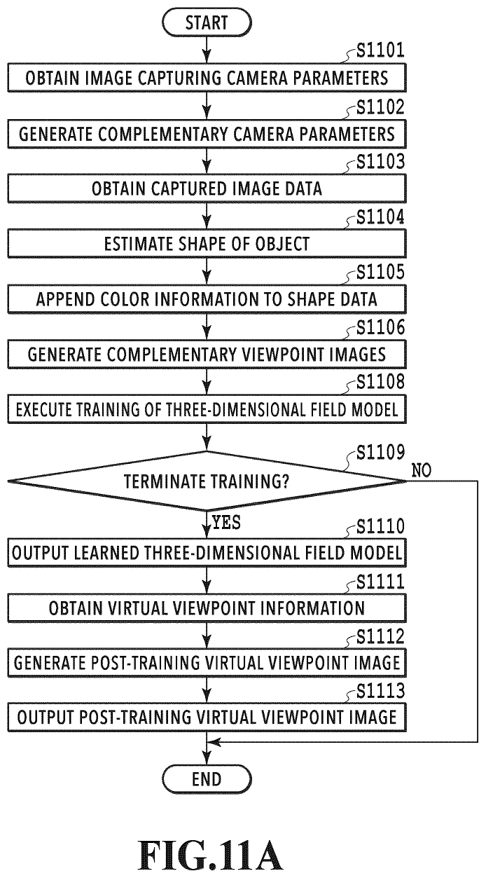

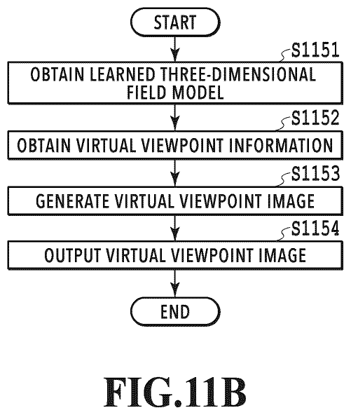

Operations of the image processing apparatus 102 and the information processing apparatus 108 will now be described with reference to FIGS. 11A and 11B. FIG. 11A is a flowchart illustrating an example of a flow of processing by the image processing apparatus 102 according to the first embodiment. First, in S1101, the camera parameter obtaining unit 1001 obtains the image capturing camera parameters of each image capturing apparatus 101. Then, in S1102, the camera parameter generation unit 1002 generates complement camera parameters.

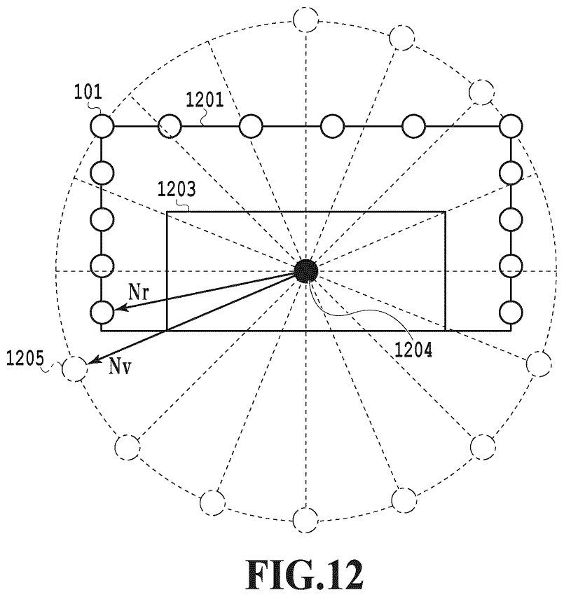

FIG. 12 is a diagram for describing an example of a method of generating the complement camera parameters with the camera parameter generation unit 1002 according to the first embodiment. FIG. 12 exemplarily illustrates a scene where a plurality of image capturing apparatuses 101 are installed on a wall surface 1201 of a studio's walls, ceiling, or the like so as to surround a training space 1203 in the studio, and a radiance field (three-dimensional field) corresponding to the training space 1203 is to be trained. Note that FIG. 12 exemplarily illustrates a cross-sectional view along a given vertical plane. In FIG. 12, the circles of solid lines indicate the positions of the image capturing apparatuses 101, and the circles of long dashed short dashed lines indicate the positions of complement viewpoints.

First, the camera parameter generation unit 1002 generates a group of direction vectors connecting a center 1204 of the training space 1203 and the image capturing apparatuses 101. The following description will be given with each direction vector in this group of direction vectors denoted as “direction vector Nr.” The camera parameter generation unit 1002 then arranges a plurality of dots on the surface of a sphere centered on the center 1204 (hereinafter referred to as “spherical surface”) and generates a group of direction vectors connecting the center 1204 and the placed dots. The following description will be given with each direction vector in this group of direction vectors denoted as “direction vector Nv.” For example, the camera parameter generation unit 1002 sets a sphere with a radius of a length equivalent to the distance from the center 1204 to the farthest image capturing apparatus 101, and arranges a plurality of dots on the sphere's surface such that the plurality of dots match the points on the Fibonacci lattice, for example. Arranging points that match the points on the Fibonacci lattice is a technique for evenly arranging a predetermined number of dots on a spherical surface.

Then, for each direction vector Nv, the camera parameter generation unit 1002 specifies the closest direction vector Nr to it. Subsequently, the camera parameter generation unit 1002 sets points corresponding to direction vectors Nv each of which forms an angle of a predetermined threshold value or more between the direction vector Nv and the paired direction vector Nr as the positions of complement viewpoints 1205. Also, the camera parameter generation unit 1002 sets the orientation of the virtual camera at each complement viewpoint 1205 based on the direction vector Nv. Subsequently, the camera parameter generation unit 1002 sets the intrinsic parameters at the complement viewpoint 1205 such that the angle of view of the virtual camera covers the entire training space 1203, for example. Note that the present embodiment will be described on the assumption that captured images and complement viewpoint images have a unified size. The camera parameter generation unit 1002 generates the complement camera parameters by setting the extrinsic parameters and the intrinsic parameters at the complement viewpoint as described above. Here, the camera parameter generation unit 1002 generates the distortion parameter or the like as a complement camera parameter as well. For example, in a case of generating an undistorted virtual viewpoint image, the camera parameter generation unit 1002 sets the distortion parameter among the complement camera parameters to a value indicating no distortion (such as zero). Thus, the camera parameter generation unit 1002 generates complement camera parameters conforming to a camera parameter format.

S1102 is followed by S1103, in which the image obtaining unit 1003 obtains captured image data obtained by image capturing by each image capturing apparatus 101. Then, in S1104, the shape obtaining unit 1004 estimates the three-dimensional shape of the object based on the image capturing camera parameters and the captured image data and generates shape data representing the three-dimensional shape of the object. Specifically, for example, the shape obtaining unit 1004 generates silhouette images by extracting regions corresponding to representations of the object from the captured images, and estimates the three-dimensional shape of the object by shape-from-silhouette using the silhouette images.

While the following description will be given on the assumption that the shape data is point cloud data indicating positions corresponding to the surface of the object in the form of a point cloud, the shape data may be data represented in the form of a polygon mesh, voxels, or the like. Also, while the three-dimensional shape of the object is estimated by shape-from-silhouette in the above description, the method of estimating the three-dimensional shape of the object is not limited to shape-from-silhouette. For example, the shape obtaining unit 1004 may estimate the three-dimensional shape of the object by utilizing sets of two neighboring image capturing apparatuses 101 as stereo cameras and estimating distances to the surface of the object with captured images obtained by image capturing by these image capturing apparatuses 101.

In S1105, based on the image capturing camera parameters and the captured image data, the second image generation unit 1005 determines the color at each point on the surface of the three-dimensional shape of the object represented by the shape data. Specifically, the second image generation unit 1005 firstly generates depth maps by projecting the three-dimensional shape with respect to the positions of the image capturing apparatuses 101 and judges, for each point on the surface of the three-dimensional shape, to which image capturing apparatus or apparatuses 101 the point is visible. Subsequently, the second image generation unit 1005 samples pixel values from the images captured by the one or more image capturing apparatuses 101 judged to be image capturing apparatuses to which the point is visible, and determines the color at the point by, for example, calculating an average value of the sampled pixel values. The second image generation unit 1005 appends color information indicating the determined color to the shape data in association with information on the corresponding point. Note that, in the present embodiment, it has been described that the second image generation unit 1005 executes the process of S1105, but the shape obtaining unit 1004 may execute the process of S1105.

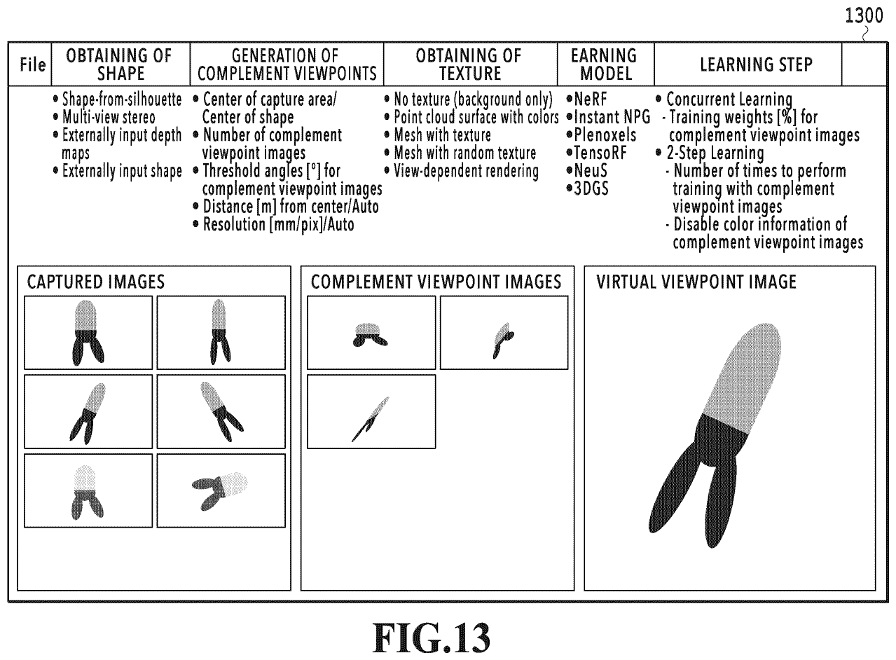

Then, in S1106, the second image generation unit 1005 generates images corresponding to views from the complement viewpoints (complement viewpoint images) based on the shape data with the color information appended thereto and the complement camera parameters. Then, in S1108, the training unit 1007 trains a three-dimensional field model with the captured image data and the complement viewpoint image data as training data. Specifically, in the present embodiment, the training unit 1007 performs the training of a radiance field by NeRF described above with the captured image data and the complement viewpoint image data as training data. During the training processing in S1108, the first image generation unit 1006 generates a virtual viewpoint image to be checked by the user. Using the virtual viewpoint image generated by the first image generation unit 1006, the output unit 1009, for example, generates a GUI to be described later with reference to FIG. 13 and outputs it to the display device of the UI panel 103, the display apparatus 105, or the like. Incidentally, in a case where the user does not need to check the virtual viewpoint image, the processing for generating the virtual viewpoint image and the GUI and the processing for outputting the GUI in S1108 may be skipped.

Then, in S1109, the training unit 1007 judges whether to terminate the training of the three-dimensional field model. For example, the training unit 1007 judges whether to terminate the training of the three-dimensional field model by judging whether the three-dimensional field model has been trained for a predetermined period or a predetermined number of times. The condition for judging whether to terminate the training of the three-dimensional field model is not limited to the above. For example, the training unit 1007 may judge whether or not the loss L has reached a predetermined threshold value or less to judge whether the training of the three-dimensional field model has converged, and thereby judge whether to terminate the training of the three-dimensional field model.

If it is judged in S1109 that the training of the three-dimensional field model is not to be terminated, the image processing apparatus 102 terminates the processing of the flowchart illustrated in FIG. 11A. Then, the image processing apparatus 102 repeats the processing of the flowchart illustrated in FIG. 11A until it is judged in S1109 that the training of the three-dimensional field model is to be terminated. In this case, the processes of S1101 and S1103 to S1105 may be omitted.

If it is judged in S1109 that the training of the three-dimensional field model is to be terminated, then in S1110, the output unit 1009 outputs the learned three-dimensional field model obtained as a result of the training by the training unit 1007. For example, in a case of outputting the learned three-dimensional field model in the form of data, the output unit 1009 outputs network parameters of the learned three-dimensional field model in the form of a file. In this case, in the present embodiment, the output unit 1009 outputs network parameters of a NeRF model representing the learned radiance field in the form of a file.

S1110 is followed by S1111, in which the information obtaining unit 1008 obtains virtual viewpoint information. Then, in S1112, the first image generation unit 1006 generates a virtual viewpoint image that is based on the virtual viewpoint information by using the learned three-dimensional field model (hereinafter this virtual viewpoint image will be referred to as “post-training virtual viewpoint image”). Then, in S1113, the output unit 1009 outputs the post-training virtual viewpoint image generated in S1112. After S1113, the image processing apparatus 102 terminates the processing of the flowchart illustrated in FIG. 11A.

Note that, in a case where the captured images are moving images, the image processing apparatus 102 repeats the processing of the flowchart illustrated in FIG. 11A each time frame data for a new time is obtained in S1103. In this case, the processes of S1101 and S1102 may be omitted. Also, the image processing apparatus 102 may generate post-training virtual viewpoint images from a plurality of virtual viewpoints by using the learned three-dimensional field model. In this case, for example, the image processing apparatus 102 repeats the processes of S1111 to S1113 each time new virtual viewpoint information is obtained in S1111. Also, in a case where the virtual viewpoint information obtained in S1111 includes information indicating a chronological series of positions and viewing directions of virtual viewpoints, the image processing apparatus 102 may repeat the processes in S1112 and S1113 to generate and output a chronological series of post-training virtual viewpoint images.

FIG. 13 is a diagram illustrating an example of a GUI 1300 that is displayed on the display device of the UI panel 103, the display apparatus 105, or the like according to the first embodiment. The GUI 1300 includes displayed images that are captured images, complement viewpoint images, and a virtual viewpoint image. Also, the GUI 1300 allows the user to set options for the training of the three-dimensional field model, such as options for the processing for obtaining the three-dimensional shape, the processing for generating complement viewpoint images, the processing for appending color information, the type of learning model, and the type of learning step. Also, the GUI 1300 allows the user to check captured images, complement viewpoint images generated by the second image generation unit 1005, and virtual viewpoint images generated using the three-dimensional field model in training and the learned three-dimensional field model.

FIG. 11B is a flowchart illustrating an example of a flow of processing by the information processing apparatus 108 according to the first embodiment. First, in S1151, the model obtaining unit 1051 obtains the learned three-dimensional field model output from the image processing apparatus 102. Then, in S1152, the information obtaining unit 1052 obtains virtual viewpoint information. Then, in S1153, using the learned three-dimensional field model obtained in S1051 and the virtual viewpoint information obtained in S1153, the image generation unit 1053 generates a virtual viewpoint image corresponding to a view from the virtual viewpoint indicated by the virtual viewpoint information (post-training virtual viewpoint image). Then, in S1154, the output unit 1054 outputs the post-training virtual viewpoint image generated in S1153. After S1154, the information processing apparatus 108 terminates the processing of the flowchart illustrated in FIG. 11B.

The image processing apparatus 102 configured as described above can avoid a decrease in the reproduction fidelity of the representation of an object included in a virtual viewpoint image in a case where the position or direction of the virtual viewpoint significantly differs from the image capturing position or orientation of any of the image capturing apparatuses 101. Also, even in cases as above, the image processing apparatus 102 can generate a three-dimensional field model capable of generating virtual viewpoint images without a decrease in the reproduction fidelity of representations of objects.

### Second Embodiment

The first embodiment has described a method in which the training of a three-dimensional field model involves setting complement viewpoints in directions where the image capturing apparatuses 101 are not present and adding complement viewpoint image data as training data to thereby avoid a deterioration in the reproduction fidelity of virtual viewpoint images corresponding to views from those directions. Here, since complement viewpoint images are virtual images generated by a simple method, it is sometimes more desirable that the training of the three-dimensional field model be optimized focusing on the colors of the captured images. A second embodiment will describe a method of obtaining a more accurate learned three-dimensional field model by performing training with complement viewpoint images (hereinafter referred to as “initial training”) and then performing training with captured images (hereinafter referred to as “main training”).

### <Configuration of Image Processing Apparatus>

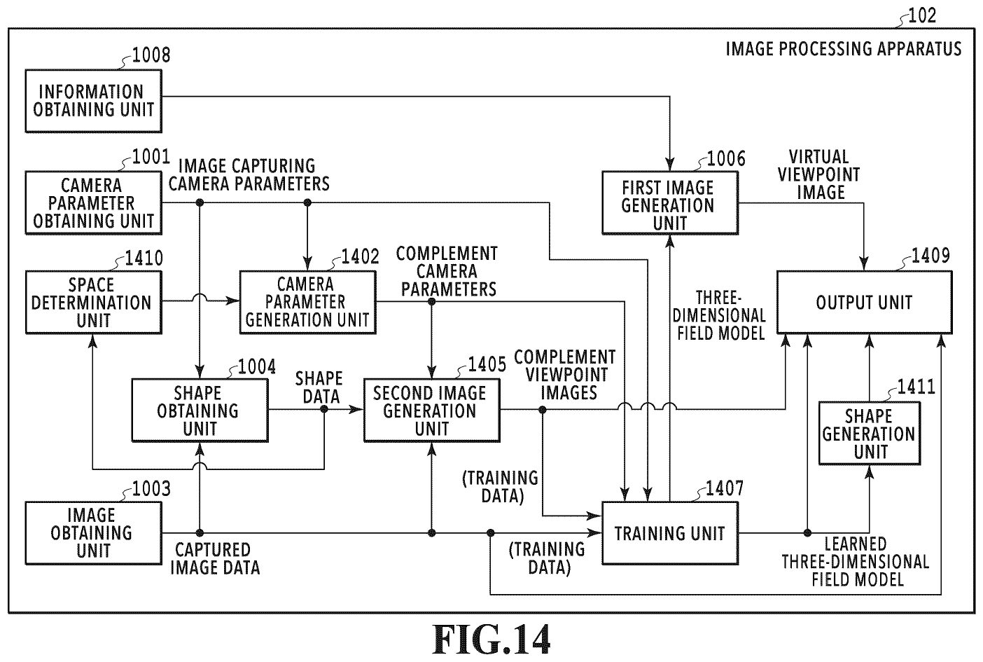

FIG. 14 is a block diagram illustrating an example of a functional configuration of an image processing apparatus 102 according to the second embodiment (hereinafter referred to simply as “the image processing apparatus 102”). Note that the image processing system according to the second embodiment has a similar configuration to that of the image processing system according to the first embodiment exemplarily illustrated in FIG. 1, and description of the configuration of the image processing system according to the second embodiment is therefore omitted. The image processing apparatus 102 has a camera parameter obtaining unit 1001, a camera parameter generation unit 1402, an image obtaining unit 1003, a shape obtaining unit 1004, a second image generation unit 1405, a first image generation unit 1006, a training unit 1407, and an information obtaining unit 1008 as its functional components. Also, the image processing apparatus 102 has an output unit 1409, a space determination unit 1410, and a shape generation unit 1411 in addition to the functional components. The functional components that are different from those of the image processing apparatus 102 according to the first embodiment will be described below.

The units included in the image processing apparatus 102 as its functional components are each implemented by causing a CPU 201 to execute a program stored in a ROM 203 or the like with a RAM 202 as a work memory. Note that not all of the processes to be described below necessarily need to be implemented by causing the CPU 201 to execute a program, and the image processing apparatus 102 may be configured to execute some or all of the processes with one or more processing circuits other than the CPU 201.

The space determination unit 1410 determines a training space based on shape data transmitted from the shape obtaining unit 1004. Specifically, for example, the space determination unit 1410 determines a space within the image capturing space that is equivalent to a cuboid accommodating the three-dimensional shape of the object indicated by the shape data as a training space. Training space information representing the training space determined by the space determination unit 1410 is output to the camera parameter generation unit 1402.

The camera parameter generation unit 1402 generates complement camera parameters based on the training space information transmitted from the space determination unit 1410 and image capturing camera parameters transmitted from the camera parameter obtaining unit 1001. Details of processing for generating the complement camera parameters by the camera parameter generation unit 1402 will be described later. The complement camera parameters generated by the camera parameter generation unit 1402 are transmitted to the first image generation unit 1006, the second image generation unit 1405, and the training unit 1407.

The second image generation unit 1405 generates a complement viewpoint image by using the complement camera parameters, captured image data, and the shape data received from the camera parameter generation unit 1402, the image obtaining unit 1003, or the shape obtaining unit 1004. Details of processing for generating the complement viewpoint image by the second image generation unit 1405 will be described later. Data of the complement viewpoint image generated by the second image generation unit 1405 is transmitted to the training unit 1407 as training data for the initial training of a three-dimensional field model in training.

The training unit 1407 performs initial training of a three-dimensional field model that uses the complement viewpoint image data as training data, and main training of the three-dimensional field model that uses the captured image data as training data. Details of processing for the training of the three-dimensional field model by the training unit 1407 will be described later. After finishing the whole training, the training unit 1407 transmits data of the learned three-dimensional field model to the output unit 1409 and the shape generation unit 1411.

The shape generation unit 1411 generates three-dimensional shape data based on the learned three-dimensional field model. Specifically, the shape generation unit 1411 generates three-dimensional shape data by extracting density information from the learned three-dimensional field model and converting the extracted information into data indicating the three-dimensional shape of the surface of the object in the form of a polygon mesh or the like. The three-dimensional shape data generated by the shape generation unit 1411 is transmitted to the output unit 1409.

The output unit 1409 outputs the three-dimensional shape data transmitted from the shape generation unit 1411. For example, the output unit 1409 outputs the three-dimensional shape data to the storage apparatus 104 to store it in the storage apparatus 104. Also, the output unit 1409 outputs the learned three-dimensional field model. For example, the output unit 1409 outputs data of the learned three-dimensional field model to the storage apparatus 104 to store the data in the storage apparatus 104. The output destination for the output unit 1409 is not limited to the storage apparatus 104. For example, the output unit 1409 may output signals of an image to be displayed that includes an image representing the learned three-dimensional field model to the display device of the UI panel 103, the display apparatus 105, or the like, to display the image on the display device. Also, the output unit 1409 may output an in-training virtual viewpoint image or a post-training virtual viewpoint image in addition to the learned three-dimensional field model. In this case, the output unit 1409, for example, outputs data of the virtual viewpoint image to the storage apparatus 104 to store the data in the storage apparatus 104. Also, the output unit 1409 may, for example, output the post-training virtual viewpoint image to the display device of the UI panel 103, the display apparatus 105, or the like to display the virtual viewpoint image on the display device.

### <Operation of Image Processing Apparatus>

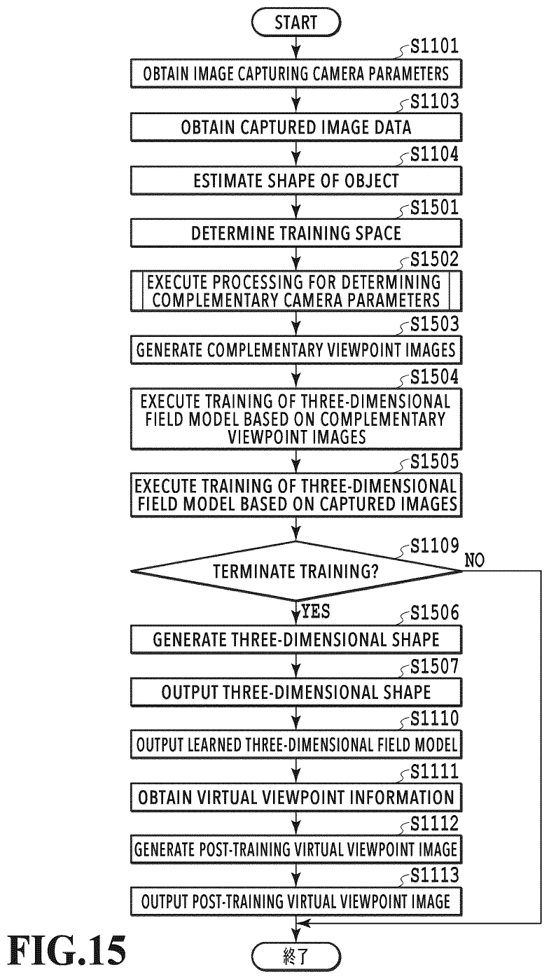

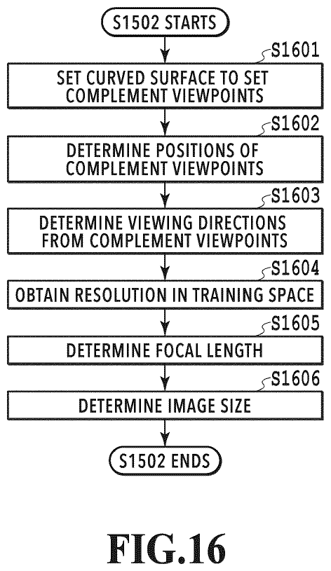

FIG. 15 is a flowchart illustrating an example of a flow of processing by the image processing apparatus 102 according to the second embodiment. First, the image processing apparatus 102 sequentially executes the processes of S1101, S1103, and S1104. S1104 is followed by S1501, in which the space determination unit 1410 determines, for example, a space accommodating a space corresponding to the three-dimensional shape of the object as a training space based on the shape data generated in S1104. Specifically, the space determination unit 1410, for example, determines a cuboidal space that is externally tangent to the space corresponding to the three-dimensional shape as a training space, and generates information indicating the training space (training space information). Then, in S1502, the camera parameter generation unit 1402 generates complement camera parameters based on the training space information generated in S1501 and the image capturing camera parameters obtained in S1101. Details of the processing for generating the complement camera parameters in S1502 will be described later using FIG. 16.

Then, in S1503, the second image generation unit 1405 generates complement viewpoint images based on the captured image data obtained in S1103, the shape data generated in S1104, and the complement camera parameters generated in S1501. Specifically, in S1503, the second image generation unit 1405 firstly projects the three-dimensional shape of the object indicated by the shape data with respect to the position of the complement viewpoint indicated by each set of complement camera parameters to thereby generate a depth map for each complement viewpoint. Subsequently, based on the depth values in each depth map, the second image generation unit 1405 obtains sets of three-dimensional coordinates corresponding to the surface of the object. Subsequently, the second image generation unit 1405 judges visibility of each of the obtained sets of three-dimensional coordinates from each image capturing apparatus 101, and samples one or more pixel values in the image captured by the image capturing apparatus 101 corresponding to the set or sets of three-dimensional coordinates judged to be visible.

Subsequently, based on the one or more sampled pixel values, the second image generation unit 1405 determines the colors of pixels in the complement viewpoint image. Specifically, if a set of three-dimensional coordinates is judged to be visible from a plurality of image capturing apparatuses 101, the second image generation unit 1405 calculates a statistical value, such as an average value, of the corresponding pixel values sampled from the images captured by these image capturing apparatuses 101 to determine the colors of pixels in the complement viewpoint image. For example, the second image generation unit 1405 calculates an addition average such that greater weights are applied to pixel values in the image captured by an image capturing apparatus 101 whose position and orientation are the same as or similar to the position and viewing direction of the complement viewpoint. Calculating such an addition average allows for a complement viewpoint image with a higher level of reproduction fidelity.

S1503 is followed by S1504, in which the training unit 1407 executes initial training of a three-dimensional field in the training space with data of the complement viewpoint images generated in S1503 as training data. During the initial training processing in S1504, the first image generation unit 1006 generates a virtual viewpoint image to be checked by the user. Using the virtual viewpoint image generated by the first image generation unit 1006, the output unit 1009 generates the GUI exemplarily illustrated in FIG. 13 and outputs it to the display device of the UI panel 103, the display apparatus 105, or the like. Incidentally, in a case where the user does not need to check the virtual viewpoint image, the processing for generating the virtual viewpoint image and the GUI and the processing for outputting the GUI in S1504 may be skipped. Then, in S1505, the training unit 1407 executes main training of the three-dimensional field in the training space with the captured image data obtained in S1103 as training data. Specifically, the main training executed in S1505 is re-training in which the three-dimensional field after the initial training in S1504 is set as initial values. During the main training processing in S1505, the first image generation unit 1006 generates a virtual viewpoint image to be checked by the user. Using the virtual viewpoint image generated by the first image generation unit 1006, the output unit 1009 generates the GUI exemplarily illustrated in FIG. 13 and outputs it to the display device of the UI panel 103, the display apparatus 105, or the like. Incidentally, in a case where the user does not need to check the virtual viewpoint image, the processing for generating the virtual viewpoint image and the GUI and the processing for outputting the GUI in S1505 may be skipped.

Then, the image processing apparatus 102 executes the process of S1109. If it is judged in S1109 that the training of the three-dimensional field model is not to be terminated, the image processing apparatus 102 terminates the processing of the flowchart illustrated in FIG. 15. Then, the image processing apparatus 102 repeats the processing of the flowchart illustrated in FIG. 15 until it is judged in S1109 that the training of the three-dimensional field model is to be terminated. In this case, the processes of S1101 and S1103 may be omitted.

If it is judged in S1109 that the training of the three-dimensional field model is to be terminated, then in S1506, the shape generation unit 1411 generates three-dimensional shape data based on the learned three-dimensional field model. S1506 is followed by S1507, in which the output unit 1409 outputs the three-dimensional shape data generated in S1506. After S1507, the image processing apparatus 102 executes the processes of S1110 to S1113. After S1113, the image processing apparatus 102 terminates the processing of the flowchart illustrated in FIG. 15.

Note that, in a case where the captured images are moving images, the image processing apparatus 102 repeats the processing of the flowchart illustrated in FIG. 15 each time frame data for a new time is obtained in S1103. In this case, the process of S1101 may be omitted. Also, the image processing apparatus 102 may generate post-training virtual viewpoint images from a plurality of virtual viewpoints by using the learned three-dimensional field model. In this case, for example, the image processing apparatus 102 repeats the processes of S1111 to S1113 each time new virtual viewpoint information is obtained in S1111. Also, in a case where the virtual viewpoint information obtained in S1111 includes information indicating a chronological series of positions and viewing directions of virtual viewpoints, the image processing apparatus 102 may repeat the processes in S1112 and S1113 to generate and output a chronological series of post-training virtual viewpoint images.

### <Processing for Generating Complement Camera Parameters>

FIG. 16 is a flowchart illustrating an example of a flow of processing for generating complement camera parameters by the camera parameter generation unit 1402 according to the second embodiment, and is a flowchart illustrating an example of the camera parameter generation processing in S1502 illustrated in FIG. 15.

First, in S1601, the camera parameter generation unit 1402 sets a curved surface on which to set complement viewpoints based on the distance from the center of the training space to each image capturing apparatus 101. Specifically, for example, the camera parameter generation unit 1402 defines a spherical surface that has a radius R equal to 10 times the largest value among the distances from the center of the training space to the image capturing apparatuses 101 and that is centered at the center of the training space, and sets this spherical surface as the curved surface on which to set complement viewpoints. Setting a longer distance from the complement viewpoints to the training space than the distances from the image capturing apparatuses 101 to the training space reduces local variations in resolution within the training space. This in turn allows for training with a constant resolution over the entire training space. Note that the above radius may be any length, and the image processing apparatus 102 may be configured such that, for example, the user may set the length of the radius R, the multiple of the distance from the center of the training space to an image capturing apparatus 101, or the like. Also, the present embodiment will be described on the assumption that the curved surface on which to set complement viewpoints are a spherical surface, the curved surface is not limited to a spherical surface.

Then, in S1602, the camera parameter generation unit 1402 determines the positions of the complement viewpoints on the curved surface set in S1601. Specifically, for example, the camera parameter generation unit 1402 determines positions on the points on a Fibonacci lattice at a distance equivalent to the above radius R from the center of the training space as the positions of the complement viewpoints. The number of points on the Fibonacci lattice is a preset number, such as 120, and the camera parameter generation unit 1402 determines the positions of all points on the Fibonacci lattice as the positions of the complement viewpoints. The user may input the number of points on the Fibonacci lattice via the UI panel 103. Also, to simplify the initial training of the three-dimensional field or for other purposes, the number of points on the Fibonacci lattice may be reduced to a predetermined number, such as 25, without significantly affecting the initial training of the three-dimensional field.

Then, in S1603, the camera parameter generation unit 1402 determines the viewing direction from each complement viewpoint determined in S1602. Specifically, the camera parameter generation unit 1402 determines, for example, the directions toward the center of the training space from the complement viewpoints as the viewing directions from the complement viewpoints. That is, the viewing directions from the complement viewpoints may be represented by direction vectors that indicate the directions toward the center of the training space from the positions of the complement viewpoints.

Then, in S1604, the camera parameter generation unit 1402 obtains the resolutions of the captured images in the training space (hereinafter referred to as “image capturing resolutions”). Specifically, first, the camera parameter generation unit 1402 calculates an image capturing resolution K [mm/pix] at the center of the training space as viewed from the position of every image capturing apparatus 101. The image capturing resolution K is calculated by, for example, dividing a depth z [mm] corresponding to the distance from the image capturing apparatus 101 to the training space by a focal length f [pix] represented by a pixel value. Subsequently, the camera parameter generation unit 1402 specifies a largest value Kmax among the image capturing resolutions K calculated for all of the image capturing apparatuses 101.

Then, in S1605, the camera parameter generation unit 1402 sets a value that is two times the largest value Kmax, which is the lowest image capturing resolution, as the resolution of complement viewpoint images (hereinafter referred to as “complement viewpoint resolution”). Here, the complement viewpoints are set on a spherical surface whose radius R is the distance to the center of the training space from the complement viewpoints and is equal to 10 times the largest value among the distances to the center of the training space from the image capturing apparatuses 101, i.e., the depths z. Thus, the complement viewpoint resolution is 2 Kmax=10 z/fi. Here, fi is the focal length from each complement viewpoint, which is a value calculated by fi=5 z/Kmax.

The initial training, which uses data of complement viewpoint images as training data, is not intended to accurately reproduce an object. That is, the purpose of the initial training is to provide initial values of the three-dimensional field model before the main training, which will use captured image data as training data, so as to avoid large differences from the actual object in views from any directions. For this reason, the initial training, which uses data of complement viewpoint images as training data, does not need to be detailed training. Accordingly, a lower resolution than the lowest image capturing resolution is set as the complement viewpoint resolution, as described above. Such a setting reduces the amount of computation in the initial training, which uses data of complement viewpoint images as training data. Note that, in the present embodiment, it has been described that the complement viewpoint resolution is set to two times the largest value Kmax among the image capturing resolutions K, but this multiplier may be any value. For example, the image processing apparatus 102 may be configured such that the user may set the multiplier via a user interface.

S1605 is followed by S1606, in which the camera parameter generation unit 1402 determines the image size of complement viewpoint images. Specifically, first, the camera parameter generation unit 1402 obtains the positions of the eight corners of the training space from the position of each single image capturing apparatus 101 in values [mm] in the horizontal and vertical directions in its camera coordinate system. Subsequently, the camera parameter generation unit 1402 specifies the smallest value [mm] and the largest value [mm] in each of the horizontal and vertical directions in all camera coordinate systems among the obtained values. Subsequently, the camera parameter generation unit 1402 divides the specified smallest value and the largest value by fi to obtain the smallest number of pixels [pix] and the largest number of pixels [pix] in each of the horizontal and vertical directions in the image coordinate systems.

Subsequently, based on the obtained smallest number of pixels [pix] and the obtained largest number of pixels [pix] in each of the horizontal and vertical directions in the image coordinate systems, the camera parameter generation unit 1402 determines the image size of complement viewpoint images. For example, the camera parameter generation unit 1402 determines the image size of complement viewpoint images by setting each of the image size in each of the horizontal and vertical directions in the image coordinate systems to the largest number of pixels—the smallest number of pixels+1. Note that the principal point of each complement viewpoint image is the determined image size/2. After S1606, the camera parameter generation unit 1402 terminates the processing of the flowchart illustrated in FIG. 16, i.e., the process of S1502.

In the present embodiment, it has been described that the complement viewpoint resolution is determined based on the image capturing resolutions K, but the method of determining the complement viewpoint resolution is not limited to this. For example, in a case where the three-dimensional field model to be trained is represented by voxels, such as in Plenoxels or TensoRF, the complement viewpoint resolution may be determined based on the size [mm] of a voxel.

As described above, the image processing apparatus 102 is configured to make the complement viewpoint resolution lower than the image capturing resolutions. Also, the image processing apparatus 102 is configured to perform, in the training of a three-dimensional field model, initial training that uses complement viewpoint image data as training data before performing main training that uses captured image data as training data. The image processing apparatus 102 configured as above can avoid a decrease in the reproduction fidelity of the three-dimensional field from directions with respect to its training space from which the image capturing apparatuses 101 are present, and also reduce the amount of computation in the initial training, which uses complement image data as training data.

### Other Embodiments

In the above-described embodiments, it has been described that complement viewpoint images are generated based on captured images, but the method of generating complement viewpoint images is not necessarily limited to this. For example, complement viewpoint images may be generated based on a random texture pattern generated artificially or by another method in advance. Generating complement viewpoint images based on a random texture pattern allows for more explicit initial training of the three-dimensional field for the density of the object from directions where the number of installed image capturing apparatuses 101 is small. It is to be note that color information of data of complement viewpoint images generated based on a random texture pattern significantly differs from that of the three-dimensional field to be actually trained. For this reason, in this case, it is preferable to initialize color-related parameters of the three-dimensional field model obtained by the initial training which uses the complement viewpoint image data as training data before the main training which uses the captured image data as training data. The image processing apparatus 102 configured in such a manner can improve the reproduction fidelity of a three-dimensional field of an object from directions where the number of installed image capturing apparatuses 101 is small.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, a three-dimensional field can be obtained which can avoid a decrease in the reproduction fidelity of a representation of an object included in a virtual viewpoint image even in a case where the position of the virtual viewpoint or the viewing direction from the virtual viewpoint significantly differs from the position or direction of any of viewpoints used in training.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-097987, filed on Jun. 18, 2024, which is hereby incorporated by reference wherein in its entirety.

What is claimed is:

1. An image processing apparatus comprising:
one or more hardware processors; and
one or more memories storing one or more programs configured to be executed by the one or more hardware processors, the one or more programs including instructions for:
obtaining data of a plurality of captured images obtained by image capturing from a plurality of positions;
obtaining a plurality of camera parameters on a plurality of viewpoints corresponding to the plurality of positions;
generating a camera parameter on a complement viewpoint that is different from the plurality of viewpoints;
obtaining shape data indicating a three-dimensional shape of an object estimated based on the obtained plurality of camera parameters and the obtained data of the plurality of captured images;
generating a complement viewpoint image corresponding to a view from the complement viewpoint based on the shape data and the generated camera parameter; and
generating three-dimensional field information on a three-dimensional field corresponding to a space that is at least part of an image capturing space subjected to image capturing from the plurality of positions, the three-dimensional field information being generated based on the obtained plurality of camera parameters, the obtained data of the plurality of captured images, the generated camera parameter, and data of the generated complement viewpoint image.

2. The image processing apparatus according to claim 1, wherein the one or more programs further include instructions for generating the shape data by estimating the three-dimensional shape of the object based on the obtained plurality of camera parameters and the obtained data of the plurality of captured images to thereby obtain the shape data.

3. The image processing apparatus according to claim 1, wherein the shape data includes color information indicating a color of a surface of the object determined based on the data of the plurality of captured images.

4. The image processing apparatus according to claim 1, wherein the shape data includes color information indicating a color of a surface of the object determined without using the data of the plurality of captured images.

5. The image processing apparatus according to claim 4, wherein the shape data includes color information indicating a color of a surface of the object determined based on image data having a predetermined texture pattern.

6. The image processing apparatus according to claim 1, wherein the one or more programs further include instructions for placing the complement viewpoint outside the image capturing space and generating a camera parameter corresponding to the complement viewpoint thus placed.

7. The image processing apparatus according to claim 6, wherein the one or more programs further include instructions for setting a position of the complement viewpoint farther from the image capturing space than the plurality of positions are from the image capturing space.

8. The image processing apparatus according to claim 1, wherein the one or more programs further include instructions for generating the complement viewpoint image at a resolution that is less than or equal to a resolution of the plurality of captured images.

9. The image processing apparatus according to claim 1, wherein the one or more programs further include instructions for determining a resolution of the complement viewpoint image to be generated according to a resolution of the three-dimensional field.

10. The image processing apparatus according to claim 1, wherein the one or more programs further include instructions for determining a space for which to generate the three-dimensional field information based on the shape data.

11. The image processing apparatus according to claim 1, wherein the three-dimensional field information is a learned model for the three-dimensional field.

12. The image processing apparatus according to claim 11, wherein the one or more programs further include instructions for generating the learned model by training a learning model for the three-dimensional field by using the data of the plurality of captured images and the data of the complement viewpoint image as training data.

13. The image processing apparatus according to claim 12, wherein the one or more programs further include instructions for making a weight on the training using the data of the plurality of captured images larger than a weight on the training using the data of the complement viewpoint image.

14. The image processing apparatus according to claim 12, wherein the one or more programs further include instructions for the training using the data of the plurality of captured images is performed after the training using the data of the complement viewpoint image.

15. The image processing apparatus according to claim 14, wherein the one or more programs further include instructions for:
after the training using the data of the complement viewpoint image, initializing information on a color of the learning model that is in training, and
training the learning model after the initialization by using the data of the plurality of captured images.

16. An image processing method comprising the steps of:
obtaining data of a plurality of captured images obtained by image capturing from a plurality of positions;
obtaining a plurality of camera parameters on a plurality of viewpoints corresponding to the plurality of positions;
generating a camera parameter on a complement viewpoint that is different from the plurality of viewpoints;
obtaining shape data indicating a three-dimensional shape of an object estimated based on the obtained plurality of camera parameters and the obtained data of the plurality of captured images;
generating a complement viewpoint image corresponding to a view from the complement viewpoint based on the shape data and the generated camera parameter; and
generating three-dimensional field information on a three-dimensional field corresponding to a space that is at least part of an image capturing space subjected to image capturing from the plurality of positions, the three-dimensional field information being generated based on the obtained plurality of camera parameters, the obtained data of the plurality of captured images, the generated camera parameter, and data of the generated complement viewpoint image.

17. A non-transitory computer readable storage medium storing a program for causing a computer to perform a control method of an image processing apparatus, the control method comprising the steps of:
obtaining data of a plurality of captured images obtained by image capturing from a plurality of positions;
obtaining a plurality of camera parameters on a plurality of viewpoints corresponding to the plurality of positions;
generating a camera parameter on a complement viewpoint that is different from the plurality of viewpoints;
obtaining shape data indicating a three-dimensional shape of an object estimated based on the obtained plurality of camera parameters and the obtained data of the plurality of captured images;
generating a complement viewpoint image corresponding to a view from the complement viewpoint based on the shape data and the generated camera parameter; and
generating three-dimensional field information on a three-dimensional field corresponding to a space that is at least part of an image capturing space subjected to image capturing from the plurality of positions, the three-dimensional field information being generated based on the obtained plurality of camera parameters, the obtained data of the plurality of captured images, the generated camera parameter, and data of the generated complement viewpoint image.
